(19) United States
(12) Patent Application Publication
(10) Pub. No.: US 2019/0311045 A1
(43) Pub. Date: Oct. 10, 2019

(54) METHOD FOR DEPICTING AND ALTERING DATA CONNECTIONS BY MEANS OF A GRAPHICAL USER INTERFACE

(71) Applicant: Products Up GmbH, Simmelsdorf (DE)

(72) Inventors: Boris Penck, Wiesbaden (DE); Kai Seefeldt, Muensing (DE)

(21) Appl. No.: 15/946,689

(22) Filed: Apr. 5, 2018

(51) Int. Cl. G06F 17/30; G06F 3/0484

(52) U.S. Cl. CPC G06F 17/3056; G06F 3/04845

(57) ABSTRACT

A method may include graphically depicting a first data record in a first area of a graphical user interface, a second data record in a second area of the graphical user interface, and at least one third data record in a third area of the graphical user interface. The first data record may have multiple first data attributes that each has an output link point, the second data record may have multiple second data attributes that each has an input link point and an output link point, and the at least one third data record may have multiple third data attributes that each has an input link point. The method may also include graphically depicting at least one first data connection that links the output link point of one of the first data attributes to the input link point of one of the second data attributes, so that the one of the first data attributes is associated with the one of the second data attributes via the at least one first data connection, and graphically depicting at least one second data connection that graphically links the output link point of one of the second data attributes to the input link point of one of the third data attributes, so that the one of the second data attributes is associated with the one of the third data attributes via the at least one second data connection. The graphical user interface may be interactable to change at least one of: (i) an association of the at least one first data connection with at least one of the respective one of the first data attributes and the respective one of the second data attributes, and (ii) an association of the at least one second data connection with at least one of the respective one of the second data attributes and the respective one of the third data attributes.

The invention relates to a method for depicting and altering data connections by means of a graphical user interface. The invention further relates to a computer program product that is set up to perform the method presented above. The invention finally relates to an apparatus that is set up to perform the method presented above.

Data conditioning and optimization require different formats and standards to be observed, data to be added or data to be adapted. This volume of data transformed from one data source to another is referred to as a “data feed”.

So that a database or a data processing system is provided with the desired data, said data need to be able to be provided in the correct format, standard and amount. In this case, it can happen that the required data can consist of different data sources.

U.S. Pat. No. 7,082,426 B2 and US2009 0319342 A1 disclose that, for online product catalogs, “Content aggregation” methods exist that allow grouped product data to be created from a large amount of product information, said product data being related by means of a product ID.

The data aggregation in this case is performed using selected variables that allow the connection between the data. These connections are present only as a form or in the output, however.

US2004 0088678 A1 and US 2005 0138 057 A1 moreover disclose a “System and method for visualizing process flows” that allows what is known as a “tree view” to be used to map and therefore visualize processes from a business and manufacture perspective.

This kind of visualization can be employed for data but not for data connections, since data connections do not have to be of hierarchic design.

U.S. Pat. No. 8,140,586 B2 moreover discloses “Computer systems and methods for the query and visualization of multidimensional databases” that allow an input of data to be depicted in different dimensions such as time, product or others. This also includes the aggregation and visualization of the data for charts and/or reports. This type of visualization can be employed for data, but not for data connections, since data connections are created in separate dimensions and resort to the data dimensions as a reference.

It is an object of the present invention to provide a visual depiction of data and data connections between these data in a user interface in a manner that is particularly clear to the user, the data connections being able to be changed or adapted by the user in a particularly user-friendly manner.

This object is achieved by the subject matter of the independent patent claims. Preferred embodiments are the subject matter of the dependent patent claims.

The method according to the invention for depicting and altering data connections by means of a graphical user interface involves a first data record being graphically depicted in a first area of the user interface, wherein the first data record has multiple first data attributes that in each case have an output link point. Similarly, a second data record is graphically depicted in a second area of the user interface, wherein the second data record has multiple second data attributes having in each case an input link point and an output link point. Further, a third data record is graphically depicted in a third area of the user interface, wherein the third data record has multiple third data attributes having in each case an input link point. Preferably, the three areas are depicted next to one another in the user interface in this case. Expediently, the first area is a left-hand area of the user interface and the third area is a right-hand area of the user interface, whereas the second area is a central area of the user interface. According to the invention, at least one first data connection is graphically depicted that links an output link point of a first data attribute to an input link point of a second data attribute, so that a first data attribute is associated with a second data attribute by means of the first data connection. According to the invention, at least one second data connection is moreover graphically depicted that graphically links an output link point of a second data attribute to an input link point of a third data attribute, so that a second data attribute is associated with a third data attribute by means of the second data connection. It is moreover essential to the invention that, according to the method, a user can interact with the user interface in order to change the association of the at least one first data connection with the respective first and/or second data attribute and/or the association of the at least one second data connection with the respective second and/or third data attribute. The method presented here thus involves all three data records and the first and second data connections linking the data records being graphically depicted simultaneously.

According to one preferred embodiment, the first and second data connections are set up/programmed such that they can be produced, changed and erased by the user by means of user interaction. This allows the desired data connections to be stipulated in a flexible manner.

Expediently, optionally at least two different third data records can be depicted with second data connections.

In a further preferred embodiment, the first data attributes of the first data record are converted into second data attributes of the second data record via the first data connections present. Similarly, this embodiment involves the second data attributes of the second data record being converted into third data attributes of the third data record via the second data connections present.

According to a further preferred embodiment, the at least two third data records differ from one another in at least one third data attribute, so that they can be exported to different output channels.

Expediently, the first and/or second and/or third data attributes can in each case be graphically depicted in first, second or third cells. Said cells can be graphically bounded by a frame, preferably by a frame of rectangular geometry. In variants, different kinds of suitable graphical depictions of the data attributes or the boundaries thereof are also possible, however. In this variant, the first and/or second and/or third data attributes are in each case graphically connected to one another by means of the first or second data connections.

As a particular preference, at least one first data connection is graphically depicted in the style of a (first) connecting line. Alternatively or additionally, at least one second data connection is graphically depicted in the style of a (second) connecting line. Expediently, the connecting lines may be configured as straight lines. In variants, other kinds of depictions, for example curved or arcuate lines, are also conceivable, however. The connecting lines are preferably configured without kinks.

According to one advantageous development, the association of the first data connections with a particular first and second data attribute can be produced, changed or erased by the user by interaction with the user interface. In this development, the change is made by moving the graphically depicted first data connection, in particular the connecting line. Alternatively or additionally, the association of the second data connections with a particular second and third data attribute can be produced, changed or erased by the user by interaction with the user interface. In this case, a change is made by moving the graphically depicted second data connection, in particular the connecting line. The movement of the data connection or of the connecting line can in this case be effected by means of a suitable input device, typically a computer mouse. In this manner, the existing data connections can be altered by the user directly, such a change made being visible in the user interface immediately.

According to a further advantageous development, the association of the first data connections, in particular of the (first) connecting lines, can be changed by the user by virtue of the first end sections of said data connections/connecting lines being moved between the first data attributes and the second end sections of said data connections/connecting lines being moved between the second data attributes. Alternatively or additionally, in this development, the association of the second data connections, in particular of the (second) connecting lines, can be changed by the user by virtue of the first end sections of said data connections/connecting lines being moved between the second data attributes and the second end sections of said data connections/connecting lines being moved between the third data attributes. This allows the desired data connections to be changed in a particularly user-friendly fashion.

Particularly expediently, the first and/or second data connections, in particular the end sections thereof, are moved by means of a user-controllable input device that is graphically depicted in the user interface. As a particular preference, such an input device may be a computer mouse.

According to one advantageous development, a graphical element is depicted in at least a first and/or second data connection, which graphical element displays the presence of at least one function associated with the first or second data connection by means of which the data transition of the respective data attribute from the first to the second data record or from the second to the third data record can be influenced.

According to a further advantageous development, the graphical element is configured as an actuation element, so that, on actuation by user interaction, information relating to the at least one function is displayed by means of the graphical user interface. This allows the user to easily display additional information relating to the at least one function when needed.

As a particular preference, on actuation of the actuation element a window is graphically depicted in the user interface, in which window the at least one function associated with the actuation element can be modified or erased or have a further function added by the user.

Expediently, the data transition from the first to the second data record or from the second to the third data record comprises changing, adding to or erasing the respective data attribute.

Particular advantage is found in a further preferred embodiment, in which the graphical element or the actuation element is graphically integrated into the respective data connection, in particular into the respective connecting line. This facilitates the association of the presence of at least one function, as indicated by the graphical element, with the respective data connection.

Preferably, the graphical element or actuation element can be depicted as a convex element, in particular as an ellipse, circle or polygon. In variants, other suitable forms of realization are also conceivable, however.

The invention further relates to a computer program product for depicting and altering data connections by means of a graphical user interface if it is executed in a computer apparatus having a display for depicting the user interface. In this case, the computer program product is set up/programmed to perform the method presented above if it is executed in the computer apparatus. The advantages of the method that are explained above therefore also transfer to the computer program product according to the invention.

The invention moreover relates to an apparatus, preferably a computer apparatus, that comprises a display device for depicting and altering data connections by means of a graphical user interface. The apparatus is further set up/programmed to perform the method presented above. The advantages of the method that are explained above therefore also transfer to the apparatus according to the invention.

Further important features and advantages of the invention will emerge from the subclaims, from the drawings and from the associated description of the figures with reference to the drawings.

It goes without saying that the features cited above and those yet to be explained below can be used not only in the respectively indicated combination but also in other combinations or on their own without departing from the scope of the present invention.

Preferred exemplary embodiments of the invention are depicted in the drawings and are explained in more detail in the description below, identical reference symbols relating to identical or similar or functionally identical components.

In the drawings, in each case schematically:

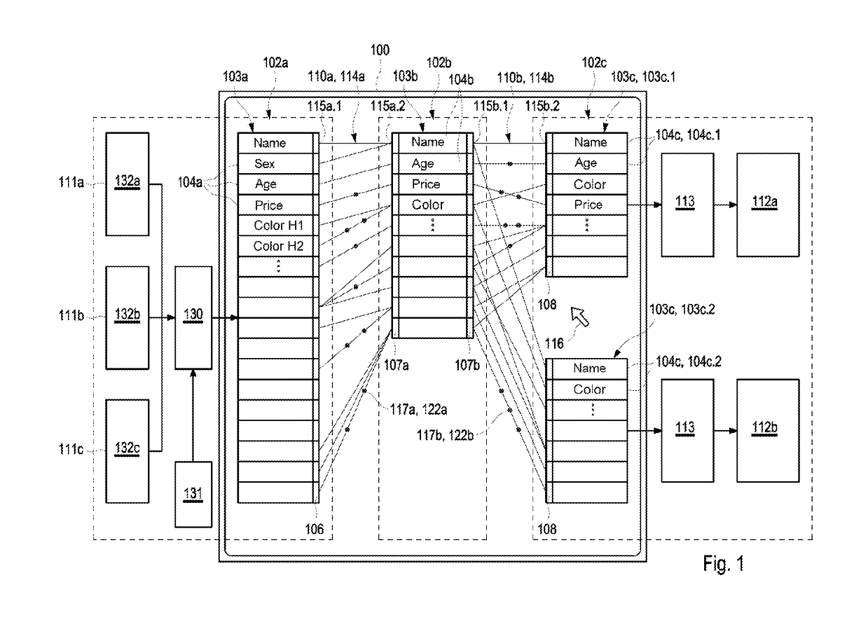

FIG. 1 shows a highly simplified depiction of a graphical user interface in which the method according to the invention is carried out,

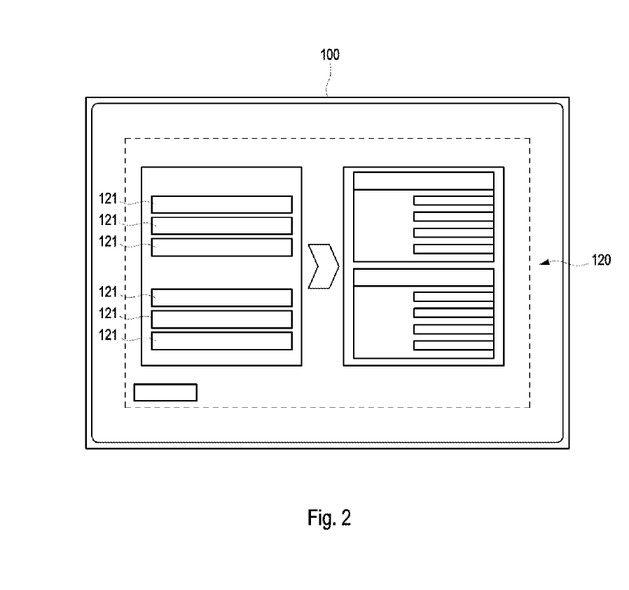

FIG. 2 shows a window that is graphically depicted in the user interface on actuation of a particular actuation element and in which user-selectable functions are depicted in the form of what are known as containers and buttons or the like.

FIG. 1 shows a graphical user interface 100 that is depicted in a suitable display device, typically a screen or a display.

Conditioning and optimizing data fundamentally requires initial data, which are subsequently also referred to as “source” or source data. The initial data describe the data to be altered using the method according to the invention or to be transmitted from import to export. These initial data can come from one or more data sources. The formats of the different initial data 132a, 132b, 132c and the initial data 132a, 132b, 132c themselves are loaded into the user interface 100 by what is known as an importer 130 and are depicted on said user interface.

It is possible that further schemes and formats, and also additional data, are needed. These can be imported by the importer 130 as additional data 131. The initial data may fundamentally be in any data format. Possible suitable data formats are in particular the formats XML, CSV, TSV, JSON, XLS and TXT.

In course of the method according to the invention being carried out, a first data record 103a is graphically depicted in a first area 102a of the user interface 100, which data record includes the imported initial data 132a, 132b, 132c, including the additional data 131. The initial data 132a, 132b, 132c can be provided, by way of example, via APIs, web services, cloud services, Excel spreadsheets, databases, shop systems, content systems, middleware or Internet pages, with the importer 130 transferring the structuring of the data to a standard data format in this case.

The first data record 130a including the initial data 132a, 132b, 132c and the additional data 130 comprises, as shown in FIG. 1, multiple graphically depicted first data attributes 104a that in each case have an output link point 106.

A second data record 103b is graphically depicted in a second area 102b of the user interface 100. The second data record 103b comprises multiple second data attributes 104b that in each case have an input link point 107a and an output link point 107b. By way of example, two third data records 103c.1 103c.2 are graphically depicted in a third area 102c of the user interface, wherein the two third data records 103c.1 103c.2 in each case have multiple third data attributes 104c having in each case an input link point 108. Moreover, first data connections 110a are graphically depicted in the user interface 100, which first data connections in each case link the output link point 106 of a first data attribute 104a to the input link point 107a of a second data attribute 104b. In this manner, a second data attribute 104b is associated with the respective first data attribute 104a by means of the first data connections 110a, and this association is graphically depicted.

Moreover, second data connections 110b are graphically depicted in the user interface 100 next to the first area 102a, which second data connections 110b in each case graphically link the output link point 107b of a second data attribute 104b to an input link point 108 of a third data attribute 104c. In this manner, a third data attribute 104c is associated with the affiliated second data attribute 104b by means of the second data connection 110b, and this association is graphically depicted.

The first data attributes 104a of the first data record 103a are imported from data sources 111a, 111b, 111c. In the example of FIG. 1, three data sources 111a, 111b, 111c are shown by way of example, these not necessarily having to be depicted in the user interface, however.

In the course of the method according to the invention, the first data attributes 104a of the first data record 103a are associated with second data attributes 104b of the second data record 103b via the first data connections 110a present. Analogously, the second data attributes 104 of the second data record are associated with third data attributes 104c of the third data record 103c via the second data connections 110b present.

The third data attributes 104c of the third data record 103c.1 are assigned to a first output channel 112a by means of the exporter 113. Similarly, the third data attributes 104c of the third data record 103c.2 are assigned to a second output channel 112b by means of the exporter 113. The two third data records 103c.1, 103c.2 produced are thus used for data export to different output channels 112a, 112b.

As FIG. 1 reveals, the first, second and third data attributes 104a, 104b, 104c are graphically depicted in each case in cells or what are known as “containers” and, at least in part, graphically connected to one another in each case by means of the first or second data connections 110a, 110b. Both the first and second data connections 110a, 110b can be depicted in the user interface 100 in each case as a connecting line 114a or 114b, as shown in FIG. 1.

When the method according to the invention is performed, a user of the user interface 100 can interact therewith in order to change the association of the first data connections 110a present with the first and second data attributes 104a, 104b. Similarly, the user of the user interface 100 can interact therewith in order to change the association of the second data connections 104b present with the respective second and third data attributes 104b, 104c. Such a change can be made by moving the relevant first data connection 110a, which is depicted as connecting line 114a. To change the association of the relevant first data connection 110a, or of the respective connecting line 114a, the user can shift, that is to say move, in particular the first end sections 115a.1 thereof between the first data attributes 104a. Similarly, the second end sections 115a.b of the relevant first data connection 110a can be shifted, that is to say moved, between the second data attributes 104b.

The association of the second data connections 110b with a particular second and third data attribute 104b, 104c can also be changed by the user by interacting with the user interface 100. Such a change can be made by moving the relevant second data connection 110b, depicted as connecting line 114b. To change the association of the relevant first data connection 110b, or of the respective connecting line 114b, the user can shift, that is to say move, the first end sections 115b.1 thereof between the second data attributes 104b. Similarly, the second end sections 115b.2 of the relevant first link 110a can be shifted, that is to say moved, between the second data attributes 104b.

It goes without saying that a particular first data attribute 104a may be linked to two or more second data attributes 104b via first data connections 110a. Similarly, it is imaginable for a particular first data attribute 104a to be linked to no second data attribute 104b via first data connections 110a. Accordingly, it is conceivable for two or more different first data attributes 104a to be linked to the same second data attribute 104b via first data connections 110a.

Analogously, it is conceivable for a particular second data attribute 104b to be linked to two or more third data attributes 104c via second data connections 110b.

Similarly, it is possible for a particular second data attribute 104b to be linked to no third data attribute 104c. For the third data attributes 104c, in turn, it holds that a particular third data attribute 104c may be linked to two or more second data attributes 104b via second data connections 110b. Similarly, however, it is also possible for a third data attribute 104c to be linked to no second data attribute 104b.

The end sections 115a.1, 115a.2, 115b.1, 115b.2 of the first and second data connections 110a, 110b can be moved by means of a user-controllable input device that is graphically depicted in the user interface 100. By way of example, the input device 116 can be depicted in the form of a mouse pointer, in particular if the input device is a computer mouse.

As FIG. 1 reveals, one or more respective graphical elements 117a and 117b may be depicted in individual first and second data connections 110a, 110b. These graphical elements 117a and 117b indicate the presence of a function associated with the respective first or second data connection 110a, 110b, which function can be used to influence the data transition of the respective data attribute 104a from the first to the second data record 103a, 103b or from the second to the third data record 103b, 103c.

The graphical elements 117a, 117b may in each case be configured as actuation elements 122a, 122b, so that, on actuation by user interaction, information relating to the respective function(s) is displayed by means of the graphical user interface 100.

As shown in FIG. 1, the graphical elements 117a, 117b realized as actuation elements 122a, 122b may be graphically integrated in the respective first or second data connection 110a, 110b, in particular in the respective connecting line 114a, 114b. In this case, the graphical elements 117a, 117b can be graphically depicted, by way of example, as circles or in the form of another suitable convex element, for example as an ellipse or as a polygon.

On actuation of a particular actuation element 122a, 122b, a window can be graphically depicted in the user interface, in which window user-selectable functions are depicted in the form of what are known as containers 120 or buttons 121 or the like.

Such containers 120 are shown by way of example in FIG. 2. Depending on what function is selected by actuation of the applicable “button”, the transition from the relevant first data attribute 104a to the second data attribute 104b, which is defined by the respective first data connection 110a in which the actuation element 122a is arranged, involves the second data attribute 104b being changed in comparison with the first data attribute 104a, added to or erased. The second data attribute 104b may alternatively remain unaltered in comparison with the first data attribute 104a. The same applies for the transition from the relevant second data attribute 104b to the third data attribute 104c, which is defined by the respective second link 110b in which the actuation element 122b is arranged. Depending on the actuated button, the third data attribute 104c is changed in comparison with the second data attribute 104b, added to or erased.

In this case, what are known as automatic functions or functions can be defined that are performed automatically on the transition from the first data record to the second data record or from the second data record to the third data record. In this case, the relevant data attribute is changed automatically on the transition from the first to the second data record or from the second to the third data record by the function. Similarly, what are known as manual functions can be defined that are likewise performed automatically by the user on the transition from the first to the second data record or from the second to the third data record, but need to be adjusted by the user.

The selection of the automatic and manual functions to be carried out on the data transition by the user can be made in the user interface 100 by means of what is known as “drag and drop”. The automatic functions are also referred to as “automapping” and normalize, connect, format, correct, add to or check the imported data on the transition from the first data record 103a to the second data record 103b and on the transition from the second data record 103b to the third data record 103c. The “data mapping” thus defined by means of the automatic and manual functions is depicted in the user interface by the aforementioned actuation element 122a or 122b as part of the first or second data connection 110a, 110b.

The second data record 103b with the second data attributes 104b forms a database in which the initial data 132a, 132b, 132c, initially imported into the first data record 103a with the first data attribute 104a, have been modified by transfer to the second data record 103b with the second data attributes 104b using the first data connections 110a. These data can be prepared for data export by means of transfer to the third data record 103c with the third data attributes 104c using the second data connections 110b.

The transition from the second data attributes 104b to the third data attributes 104c that is defined by means of the second data connections 110b allows the provision of data that are structured for the respective export. It should be noted that two or more different third data records 103c with third data attributes 104c can be provided that may be connected to the second data record 103b by individual second data connections 110b. In this manner, different data can be exported that differ in regard to content, volume of data, data optimization and data format.

An exemplary application of the exemplary embodiment of the invention explained above is presented below:

A reseller wishes to integrate what are known as “international market places” and other suitable platforms for selling and depicting his products on the Internet into his existing shop system. To do so, he imports his product master data, such as product image, product title, product description, product specifications, as first initial data 132a, and price, number in stock, dispatch information, as second initial data 132b, into the first data attributes 104a of the first data record 103a. The reseller separates these two initial data 132a, 132b, since he uses different file formats and sources for these source data. Moreover, his product master data for the two first initial data 132a 1 change only lx daily, whereas his stock and price data, included in the second initial data 132b, need to be checked and transmitted “live”, which means that he chooses not only a different format but also a different form of transmission here, in this case API.

As additional data 131 for his product data, the reseller now also connects a GTIN web service, which enriches his product data with standardized manufacturer data on the basis of the GTIN and adds these in the first data record 103b. The initial data 132a, 132b, 132c and additional data 131 defined in this manner are linked and depicted as first data record 104a.

The standardization, structuring, conditioning and filtering of the first data attributes 104a into second data attributes 104b, that is to say the transition from the first data attributes 104a to second data attributes 104b, is now effected via the first data connections 110a between the first and second data records 103a and 103b. It can be seen that the first data attributes “name”, “gender”, “age”, “price”, “color #1”, “color #2” are associated with the second data attributes “name”, “age”, “price”, “color #1”, “color #2”. In the example scenario, the first two data attributes “name”, “gender” are thus associated with a common second data attribute with the designation “name”, which therefore also includes the information about gender. By means of the first data connections 110a, the reseller can thus easily and conveniently stipulate which of the first data attributes 104a he wishes to continue to use in the second data record 103b and in what manner the association between the first and second data attributes 104a, 104b is supposed to be made. The data attributes 104b thus obtained are available to the user as editable, combined and adapted data attributes in the second data record 103b, where they are conditioned for individual export to different platforms, market places, etc.

In the first data connections 110a, it is possible, as already explained, for graphical elements 117a to be depicted that display the presence of at least one function associated with the first data connection 110a, for example for normalization, mapping, formatting, corrections, etc., of the relevant first data attribute 104a. By means of said functions, it is thus possible for the data transition of the respective data attribute 104a from the first to the second data record 103b to be influenced. Since the graphical elements 117a may be configured as actuation elements 122a, said functions for normalization, mapping, formatting, corrections, etc., can be altered by the user and adapted to suit individual requirements.

The data attributes 104b thus obtained are available to the user as editable, combined and adapted data attributes in the second data record 103b, where they are conditioned for individual export to different platforms, market places, etc. The adaptation to suit the export of the data takes place in this case in the course of the transition of the second data attributes 104b of the second data record 103b to the third data attributes 104c of the third data record 103c by means of the second data connections 110b. In the second data connections 110b too, analogously to the first data connections 110a, graphical elements 117b and actuation elements 122b are depicted that can be combined with functions for preparing different exports.

The preparation of the data export is thus fundamentally effected by associating the second data attributes 104b of the second data record 103b with third data attributes 104c of the third data record 103c by means of the second data connections 110b. The transition from the second data record 103b to the third data record 103c.1 or 103c.2 or from the second data attributes 104b to the third data attributes 104c.1 or 104c.2 can be used to adapt the data conditioned in standard fashion in the course of the import individually to suit different data formats.

For different output channels 112a, 112b adapted to suit respective individual requirements of the platforms processing the output data further, it is thus possible for individual third data attributes 104c to be stipulated via the second data connections 110b. The association between the second and third data records 103b, 103c by means of the second links 110b is thus platform-specific, i.e. different third data attributes 104c can be linked to the second data attributes 104b via individually stipulated second data connections 110b, depending on the target platform.

For clarification purposes, FIG. 1 depicts two third data records 103c.1, 103c.2 with respective third data attributes 104c.1, 104c.2. The third data record 103c.1 is adapted to suit a particular first platform for the export of the output data via a first output channel 112a. The third data record 103c.2 is adapted to suit a particular second platform for the export of the output data via a second output channel 112b.

As a preference, in the course of the method according to the invention, only a single third data record 103c.1 or 103c.2 is depicted in the user interface for reasons of clarity.

It is moreover possible for different output data to be transferred to the same output channel 112a, 112b, since a platform can occur in different markets, such as countries, and therefore admittedly has the same data format but includes different data.

In the second data connections 110b too, graphical elements 117b or actuation elements 122b are depicted that can be combined with functions for preparing different exports.

In the method presented here, the complete workflow of the initial data 132a, 132b, 132c, imported into the first data record 103a, via the second data record 103b and the third data records 103c.1, 103c.2 into the output channels 112a, 112b can be graphically processed visually, adapted or rebuilt by the user at any time by virtue of the first and second data connections 110a, 110b being adapted as appropriate.

1. A method for depicting and altering data connections by means of a graphical user interface, comprising:
graphically depicting a first data record in a first area of the graphical user interface, wherein the first data record has multiple first data attributes that each has an output link point;
graphically depicting a second data record in a second area of the graphical user interface, wherein the second data record has multiple second data attributes that each has an input link point and an output link point;
graphically depicting at least one third data record in a third area of the graphical user interface, wherein each of the at least one third data record has multiple third data attributes that each has an input link point;
graphically depicting at least one first data connection that links the output link point of one of the first data attributes to the input link point of one of the second data attributes, so that the one of the first data attributes is associated with the one of the second data attributes via the at least one first data connection; and
graphically depicting at least one second data connection that graphically links the output link point of one of the second data attributes to the input link point of one of the third data attributes, so that the one of the second data attributes is associated with the one of the third data attributes via the at least one second data connection;
wherein the graphical user interface is interactable to change at least one of: (i) an association of the at least one first data connection with at least one of the respective one of the first data attributes and the respective one of the second data attributes, and (ii) an association of the at least one second data connection with at least one of the respective one of the second data attributes and the respective one of the third data attributes.

2. The method as claimed in claim 1, wherein the at least one first data connection and the at least one second data connection are configured and depicted such that they can be produced, changed and erased by user interaction.

3. The method as claimed in claim 1, wherein optionally at least two different third data records are depicted or are depictable with respective second data connections.

4. The method as claimed in claim 1, further comprising:
converting the first data attributes of the first data record into second data attributes of the second data record via respective ones of the at least one first data connection; and
converting the second data attributes of the second data record into third data attributes of the at least one third data record via respective ones of the at least one second data connection.

5. The method as claimed in claim 1, wherein the at least one third data record includes at least two third data records differing from one another in at least one third data attribute, so that they are exported to different output channels.

6. The method as claimed in claim 1, wherein:
at least one of the first data attributes, the second data attributes, and the third data attributes are in each case depicted in first cells, second cells, or third cells; and
the at least one of the first data attributes, the second data attributes, and the third data attributes are in each case graphically connected to one another via one of the first data connection or the second data connection.

7. The method as claimed in claim 1, wherein at least one of:
the at least one first data connection is graphically depicted as a connecting line; and
the at least one second data connection is graphically depicted as a connecting line.

8. The method as claimed in claim 1, wherein at least one of:
the association of the at least one first data connection with a particular first data attribute and a second data attribute can be produced, changed or erased by interaction with the graphical user interface, wherein a change is made by moving the graphically depicted ta to least one first data connection; and
the association of the at least one second data connection with a particular second data attribute and a third data attribute can be produced, changed, or erased by interaction with the graphical user interface, wherein a change is made by moving the graphically depicted at least one second data connection.

9. The method as claimed in claim 1, wherein at least one of:
the association of the at least one first data connection is changeable by virtue of a first end sections of said at least one first data connection being moved between the first data attributes, and a second end sections of said at least one first data connection being moved between the second data attributes and
the association of the at least one second data connection by virtue of a first end section of said at least one second data connection being moved between the second data attributes, and a second end section of said at least one second data connection being moved between the third data attributes.

10. The method as claimed in claim 1, wherein at least one of the first data connection and the second data connection are moved via a user-controllable input device that in the graphical user interface.

11. The method as claimed in claim 1, wherein a graphical element is depicted in at least one of the at least one first data connection and the at least one second data connection, the graphical element displaying a presence of at least one function associated with the at least one of the first data connection and the at least one second data connection via which a transition of the respective data attribute from the first data record to the second data record or from the second data record to the at least one third data record can be influenced.

12. The method as claimed in claim 11, wherein the graphical element is configured as an actuation element, so that, on actuation by a user interaction, information relating to the at least one function is displayed via the graphical user interface.

13. The method as claimed in claim 12, wherein on actuation of the actuation element, a window in which the at least one function associated with the actuation element can be one of modified, erased, and have a further function added by a user.

14. The method as claimed in claim 11, wherein the transition of the respective data attribute includes one of changing, adding to, and erasing the respective data attribute.

15. The method as claimed in claim 11, wherein the graphical element is graphically integrated into the respective data connection.

16. The method as claimed in claim 11, wherein the graphical element is graphically depicted as a convex element.

17. A non-transitory computer readable medium tangibly embodying computer-executable instructions that when executed by a processor cause the processor to perform operations comprising:
graphically depicting a first data record in a first area of a graphical user interface, wherein the first data record has multiple first data attributes that each has an output link point;
graphically depicting a second data record in a second area of the graphical user interface, wherein the second data record has multiple second data attributes that each has an input link point and an output link point;
graphically depicting at least one third data record in a third area of the graphical user interface, wherein each of the at least one third data record has multiple third data attributes that each has an input link point;
graphically depicting at least one first data connection that links the output link point of one of the first data attributes to the input link point of one of the second data attributes, so that the one of the first data attributes is associated with the one of the second data attributes via the at least one first data connection; and
graphically depicting at least one second data connection that graphically links the output link point of one of the second data attributes to the input link point of one of the third data attributes, so that the one of the second data attributes is associated with the one of the third data attributes via the at least one second data connection;
wherein the graphical user interface is interactable to change at least one of: (i) an association of the at least one first data connection with at least one of the respective one of the first data attributes and the respective one of the second data attributes, and (ii) an association of the at least one second data connection with at least one of the respective one of the second data attributes and the respective one of the third data attributes.

18. An apparatus comprising a display device for depicting and altering data connections via a graphical user interface, and a processor configured to:
graphically depict a first data record in a first area of the graphical user interface, wherein the first data record has multiple first data attributes that each has an output link point;
graphically depict a second data record in a second area of the graphical user interface, wherein the second data record has multiple second data attributes that each has an input link point and an output link point;
graphically depict at least one third data record in a third area of the graphical user interface, wherein each of the at least one third data record has multiple third data attributes that each has an input link point;
graphically depict at least one first data connection that links the output link point of one of the first data attributes to the input link point of one of the second data attributes, so that the one of the first data attributes is associated with the one of the second data attributes via the at least one first data connection; and
graphically depict at least one second data connection that graphically links the output link point of one of the second data attributes to the input link point of one of the third data attributes, so that the one of the second data attributes is associated with the one of the third data attributes via the at least one second data connection;
wherein the graphical user interface is interactable to change at least one of: (i) an association of the at least one first data connection with at least one of the respective one of the first data attributes and the respective one of the second data attributes, and (ii) an association of the at least one second data connection with at least one of the respective one of the second data attributes and the respective one of the third data attributes.

19. The method as claimed in claim 16, wherein the convex element is one of an ellipse, a circle, or a polygon.

20. The method as claimed in claim 2, wherein optionally at least two different third data records are depicted or are depictable with respective second data connections.
